(19) United States
(12) Patent Application Publication
(10) Pub. No.: US 2012/0331510 A1
(43) Pub. Date: Dec. 27, 2012

(54) METHOD, SERVER AND SYSTEM FOR PROVIDING REAL-TIME VIDEO SERVICE IN TELECOMMUNICATION NETWORK

(75) Inventors: Lin LIN, Shenzhen (CN); Xiaojun MO, Shenzhen (CN); Pu ZHANG, Shenzhen (CN); Dexi QIN, Shenzhen (CN)

(73) Assignee: HUAWEI TECHNOLOGIES CO., LTD., Shenzhen (CN)

(21) Appl. No.: 13/606,804

(22) Filed: Sep. 7, 2012

Related U.S. Application Data
(63) Continuation of application No. PCT/CN2011/071468, filed on Mar. 3, 2011.

(30) Foreign Application Priority Data
Mar. 29, 2010 (CN) 201010137010.1

(51) Int. Cl. H04N 21/40

(52) U.S. Cl. 725/62

(57) ABSTRACT

Embodiments of the present invention provide a method, a server and a system for providing a real-time video service in a telecommunication network. The method includes: receiving a video content obtaining request from a telecommunication video resource platform; obtaining, according to the video content obtaining request, data content that is of a web server and corresponds to the video content obtaining request; converting the data content into display content in a video form; and sending the display content in the video form. In the embodiments of the present invention, a capability of generating video content in real time according to dynamic information is achieved, and the real-time video service is provided in the telecommunication network.

### CROSS-REFERENCE TO RELATED APPLICATIONS

This application is a continuation of International Application No. PCT/CN2011/071468, filed on Mar. 3, 2011, which claims priority to Chinese Patent Application No. 201010137010.1, filed on Mar. 29, 2010, both of which are hereby incorporated by reference in their entireties.

### FIELD OF THE INVENTION

The present invention relates to the field of telecommunications, and in particular, to a method, a server and a system for providing a real-time video service in a telecommunication network.

### BACKGROUND OF THE INVENTION

A video feature is introduced in a 3G (3rd-generation, third generation mobile communication technology) and an NGN (Next Generation Network, next generation network) network, so that development of a video service that is based on a voice channel domain is possible. Through a video technology of a telecommunication network, a user may dial a specific access code at a video terminal, to enter a video system that is based on the voice channel domain, and experience a video service. The telecommunication video service just develops, so an existing service development system is suitable for presenting and playing of static video information, such as a video ring back tone service or a video on demand service. For presenting and playing of video information that needs to be generated dynamically, for example, services such as viewing a call record of a user, viewing a call fee of the user, and viewing a service handling state of the user through a video telephone, a specially customized service is required for querying, at a telecommunication video platform according to a user number, relevant information of the user and then converting the relevant information into a variety of video effects and presenting the video effects to the user.

A video application in the telecommunication network just develops, and because of features of the telecommunication network which are a large user base and a service usage simper than the Internet, main capabilities provided by a device for providing a video capability in a typical network are capabilities of large capacity video format converting and video file playing.

In the implementation of the present invention, the inventor finds that the prior art at least has the following problems: most video devices in an existing telecommunication network do not have a capability of generating video content dynamically in real time according to dynamic information.

### SUMMARY OF THE INVENTION

Embodiments of the present invention provide a method, a server and a system for providing a real-time video service in a telecommunication network, which have a capability of generating video content in real time dynamically according to dynamic information.

In one aspect, an embodiment of the present invention provides a method for providing a real-time video service in a telecommunication network, and the method includes: receiving a video content obtaining request from a telecommunication video resource platform; obtaining, according to the video content obtaining request, data content that is of a web server and corresponds to the video content obtaining request; converting the data content into display content in a video form; and sending the display content in the video form.

In another aspect, an embodiment of the present invention provides a video conversion server for providing a real-time video service in a telecommunication network, and the video conversion server includes: a receiving unit, configured to receive a video content obtaining request from a telecommunication video resource platform; an obtaining unit, configured to obtain, according to the video content obtaining request, data content that is of a web server and corresponds to the video content obtaining request; a converting unit, configured to convert the data content into display content in a video form; and a sending unit, configured to send the display content in the video form.

In another aspect, an embodiment of the present invention provides a system for providing a real-time video service in a telecommunication network, which includes: a video conversion server, configured to receive a video content obtaining request from a telecommunication video resource platform, obtain, according to the video content obtaining request, data content that is of a web server and corresponds to the video content obtaining request, convert the data content into display content in a video form, and send the display content in the video form; and the telecommunication video resource platform, configured to send the video content obtaining request to the video conversion server.

The foregoing technical solutions have the following beneficial effects: technical measures of receiving the video content obtaining request from the telecommunication video resource platform, obtaining, according to the video content obtaining request, the data content that is of a web server and corresponds to the video content obtaining request, converting the data content into the display content in the video form, and sending the display content in the video form are adopted, so the capability of generating video content dynamically in real time according to dynamic information is achieved, and the real-time video service is provided in the telecommunication network.

### BRIEF DESCRIPTION OF THE DRAWINGS

To illustrate technical solutions in embodiments of the present invention more clearly, accompanying drawings to be used for describing the embodiments are introduced briefly in the following. Apparently, the accompanying drawings in the following description are only some embodiments of the present invention, and persons of ordinary skill in the art can derive other drawings from these accompanying drawings without making creative efforts.

FIG. 1 is a flow chart of a method for providing a real-time video service in a telecommunication network according to an embodiment of the present invention;

FIG. 2 is a schematic diagram of networking relationships between a video conversion server and a telecommunication video resource platform, a web server and a telecommunication user according to an embodiment of the present invention;

FIG. 3 is a schematic structural diagram of a video conversion server for providing a real-time video service in a telecommunication network according to an embodiment of the present invention;

FIG. 4 is a schematic flow chart of providing a real-time video service in a telecommunication network according to a first instance of the present invention;

FIG. 5 is a schematic flow chart of providing a real-time video service in a telecommunication network according to a second instance of the present invention;

FIG. 6 is a schematic flow chart of providing a real-time video service in a telecommunication network according to a third instance of the present invention;

FIG. 7 is a schematic flow chart of providing a real-time video service in a telecommunication network according to a fourth instance of the present invention;

FIG. 8 is a schematic flow chart of providing a real-time video service in a telecommunication network according to a fifth instance of the present invention;

FIG. 9 is an improved schematic structural diagram in which a video conversion server management node has been added on basis of FIG. 2 according to an embodiment of the present invention;

FIG. 10 is a schematic flow chart of providing a real-time video service in a telecommunication network according to a sixth instance of the present invention; and

FIG. 11 is schematic structural diagram of a system for providing a real-time video service in a telecommunication network according to an embodiment of the present invention.

### DETAILED DESCRIPTION OF THE EMBODIMENTS

Technical solutions of the present invention are clearly and completely described in the following with reference to accompanying drawings. It is obvious that the embodiments to be described are only part rather than all of the embodiments of the present invention. All other embodiments, which persons of ordinary skill in the art obtain based on the embodiments of the present invention without making creative efforts, fall within the protection scope of the present invention.

In an existing computer technology, an IE browser obtains, according to a URL (Uniform/Universal Resource Locator, uniform resource locator), FTP (File Transfer Protocol) or HTML (Hyper Text Mark-up Language, hyper text mark-up language) data from a Web Server (web server), converts the data into a web page interface according to HTML language description, and presents the web page interface on a display for a user to view. Therefore, as long as content displayed on the display by the IE browser is converted into a video form by using a certain method and sent to a telecommunication video resource platform, and then is sent to a terminal user or directly sent to a device in a telecommunication network by the telecommunication video resource platform, web page content may be played to the user. In this way, a web page edit tool may be used to quickly and conveniently develop a telecommunication video service for real time information, and an effect of what you see is what you get is achieved.

### Embodiment 1

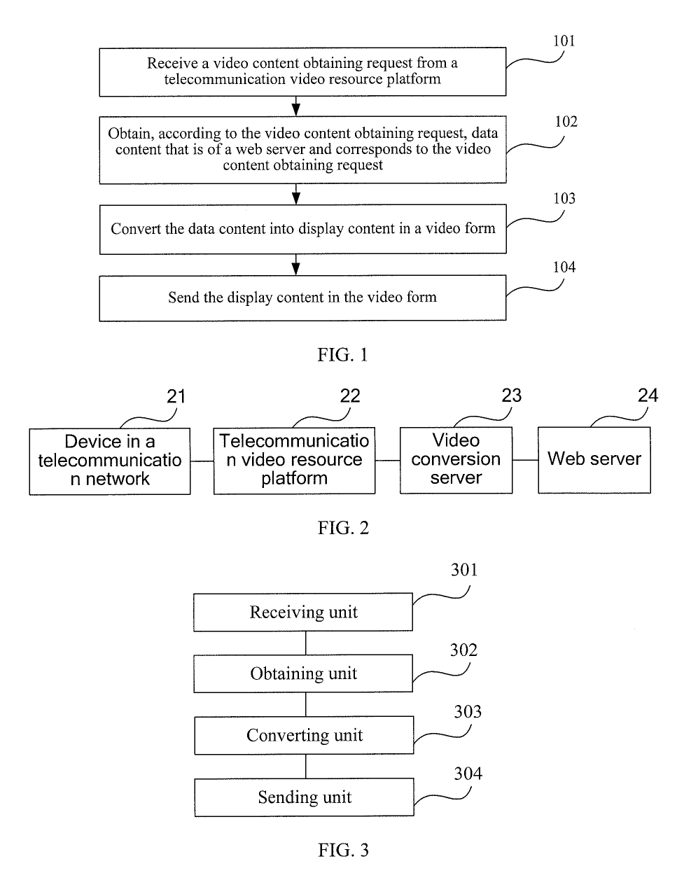

As shown in FIG. 1, it is a flow chart of a method for providing a real-time video service in a telecommunication network according to an embodiment of the present invention, where the method includes:

101: Receive a video content obtaining request from a telecommunication video resource platform.

Optionally, the receiving the video content obtaining request from the telecommunication video resource platform may include: receiving a video content obtaining request sent by the telecommunication video resource platform, or after video content obtaining requests are distributed by a video conversion server management node, receiving a video content obtaining request sent by the telecommunication video resource platform.

102: Obtain, according to the video content obtaining request, data content that is of a web server and corresponds to the video content obtaining request.

Optionally, according to a URL in the video content obtaining request, data content that is in a web page form, is of a web server and corresponds to the URL may be obtained.

103: Convert the data content into display content in a video form.

Optionally, the video form may be an image or a media stream, which is described in detail in an application instance in the following and not described in detail here.

104: Send the display content in the video form.

Optionally, the sending the display content in the video form may include: sending the display content in the video form to the telecommunication video resource platform, where the video form is the image or the media stream; or sending the display content in the video form to a device in the telecommunication network, where the device in the telecommunication network may include one of the following: a terminal of an IP multimedia subsystem (IP Multimedia Subsystem, IMS) network, or a terminal of a next generation network (Next Generation Network, NGN), or a 3G video gateway (Video Gateway, VIG) in the telecommunication network. A network transmission protocol of the display content in the video form may be the Real-time Transport Protocol (Real-time Transport Protocol, RTP) and the RTP Control Protocol (RTP Control Protocol, RTCP).

Optionally, after establishing a session with the telecommunication video resource platform in one of the following session establishing manners: FTP, HTTP, the Session Initiation Protocol (Session Initiation Protocol, SIP), and the Real-time Streaming Protocol (Real Time Streaming Protocol, RTSP), the display content in a video form may be sent to the telecommunication video resource platform.

In the foregoing technical solution of the embodiment of the present invention, technical measures of receiving a video content obtaining request from a telecommunication video resource platform, obtaining, according to the video content obtaining request, data content that is of a web server and corresponds to the video content obtaining request, converting the data content into display content in a video form, and sending the display content in the video form are adopted, so a capability of generating the video content dynamically in real time according to dynamic information is got, and the real-time video service is provided in the telecommunication network.

### Embodiment 2

In the foregoing method technical solution of the embodiment of the present invention, a device for converting web page content into video content may be referred to as a video conversion server, and its networking relationships with a telecommunication video resource platform, a web server and a device in a telecommunication network are shown in FIG. 2. It should be noted that, the video conversion server 23 may be located between the telecommunication video resource platform 22 (the telecommunication video resource platform 22 is connected to the device 21 in a telecommunication network) and the web server 24, and may also be integrated in the web server 24, which does not serve as a limitation on the embodiment of the present invention.

As shown in FIG. 3, it is a schematic structural diagram of a video conversion server for providing a real-time video service in a telecommunication network according to an embodiment of the present invention, where the video conversion server includes:

a receiving unit 301, configured to receive a video content obtaining request from a telecommunication video resource platform;

an obtaining unit 302, configured to obtain, according to the video content obtaining request, data content that is of a web server and corresponds to the video content obtaining request;

a converting unit 303, configured to convert the data content into display content in a video form; and

a sending unit 304, configured to send the display content in the video form.

Optionally, the obtaining unit 302 may further be configured to, according to a uniform resource locator URL in the video content obtaining request, obtain data content that is in a web page form, is of the web server and corresponds to the URL. The sending unit 304 may further be configured to send the display content in the video form to the telecommunication video resource platform, where the video form may be an image or a media stream, or may be configured to send the display content in the video form to a device in the telecommunication network, where the device in the telecommunication network may include one of the following: a terminal of an IMS network, or a terminal in an NGN network, or a VIG in the telecommunication network. For the sending unit 304, a network transmission protocol used for sending the display content in a video form may be RTP and RTCP.

Optionally, the video conversion server may further include: a session establishing unit, configured to establish a session with the telecommunication video resource platform in one of the following session establishing manners: FTP, HTTP, the Session Initiation Protocol SIP, and the Real-time Streaming Protocol RTSP. Afterwards, the sending unit sends the display content in the video form to the telecommunication video resource platform. The receiving unit 301 is further configured to receive the video content obtaining request sent by the telecommunication video resource platform.

Detailed descriptions are provided in the following:

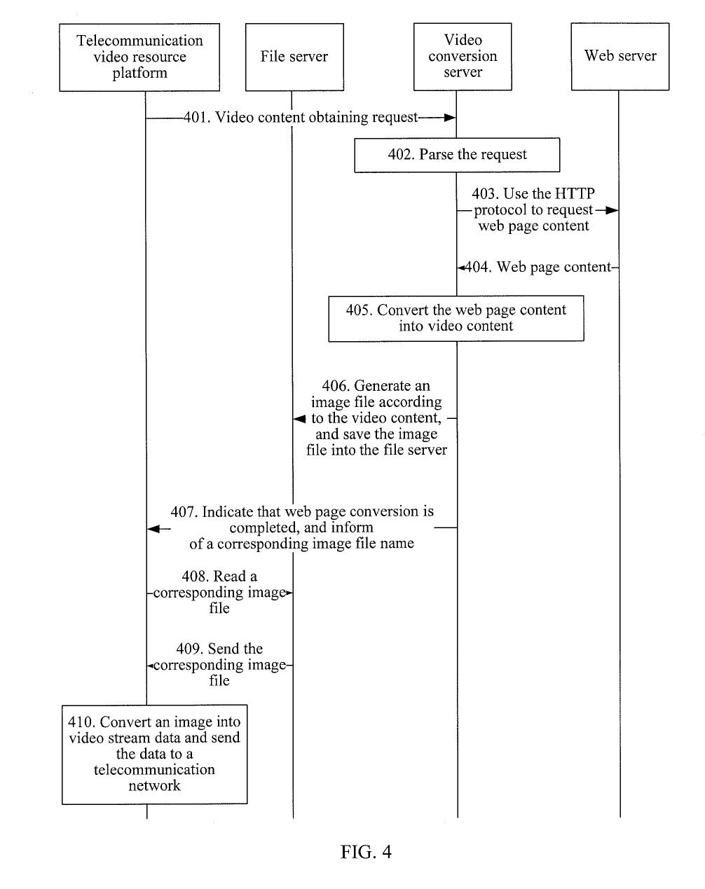

(1) As shown in FIG. 4, it is a schematic flow chart of providing a real-time video service in a telecommunication network according to a first instance of the present invention, which specifically includes:

401: A video conversion server receives a video content obtaining request from a telecommunication video resource platform, where the video content obtaining request includes a URL.

402: The video conversion server parses the video content obtaining request, obtains the URL included in the video content obtaining request, and obtains, according to the URL, web server address information corresponding to the URL.

403: The video conversion server uses the HTTP protocol to request web page content of a web server, according to the web server address information.

404: The video conversion server receives the web page content sent by the web server.

405: The video conversion server converts the web page content into video content.

The video conversion server may implement this function through a computer in a manner that is based on an IE browser, taking a Trident as a kernel, and using a screen capture (VC6.0), where the manner is the simplest, and a accessed web page needs to be displayed on the screen to be obtained, and cannot be completely obtained if it is beyond a screen or is blocked by another window. Alternatively, a picture that is beyond the screen or blocked by another window may be captured through WM_PRINT drawing. Screen capturing without displaying a web page may be implemented through an interface provided by IHTMLDocument2, such as an IHTMLDocument2—IHTMLElement—IHTMLElementRender::DrawToDC manner (VC7.0), and IHTMLDocument2—IViewObject::Draw (C# . . . ), a recommended best manner based on a IE kernel is adopting a Draw method provided by a COM object IViewObject, and the web page content may be converted into the video content by using a computer through the foregoing manners.

406: The video conversion server generates an image file from the video content, and saves the image file into a file server.

It should be noted that, the file server may be an independently existed physical entity, and may be integrated in the video conversion server or the telecommunication video resource platform. A format of the image saved in the file server by the video conversion server is only required to be supported by the telecommunication video resource platform, for example, an image format such as BMP or JPG.

407: The video conversion server sends a conversion success message to the telecommunication video resource platform, where the conversion success message indicates that the video content of the web page is successfully converted into the image file, and the message may further include an image file name corresponding to the image file.

An image file name saved in the file server may be designated when the telecommunication video resource platform sends a request to the video conversion server. In step 406, when image content is generated from the video content, a corresponding image file name is designated by the telecommunication video resource platform.

408: The telecommunication video resource platform sends an obtaining request to the file server according to the image file name, where the obtaining request includes the image file name.

409: After receiving the obtaining request, the file server sends, according to the image file name, the telecommunication video resource platform the image file corresponding to the image file name.

410: The telecommunication video resource platform converts the obtained image file into video stream data to send the video stream data to the telecommunication network.

Here, the video conversion server may implement this function through a computer. The video stream data may be sent through a network transmission protocol such as RTP or RTCP to a device in the telecommunication network. It should be noted that, a video stream may also be transmitted through another protocol such as the H.324M protocol, which does serve as a limitation on the embodiment of the present invention.

The foregoing application instance of the present invention is applied to a scenario where dynamic information has a few changes. A reason why the image file is generated in the halfway is that, for a video stream displaying, for example, a table, a picture changes rarely and different pictures may be captured through a screen capture software to be saved as image files, which saves storage capacity, and may improve processing performance of the video conversion server and the telecommunication video resource platform.

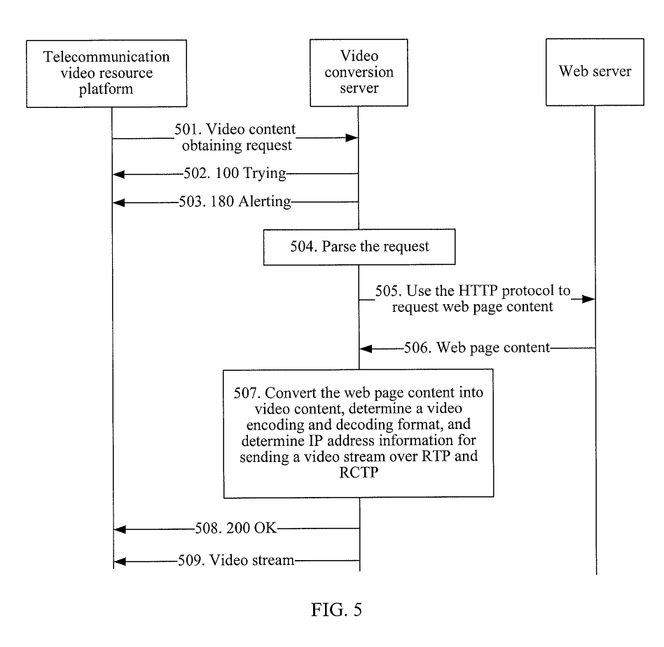

(2) As shown in FIG. 5, it is a schematic flow chart of providing a real-time video service in a telecommunication network according to a second instance of the present invention, which specifically includes:

501: A video conversion server receives a video content obtaining request sent from a telecommunication video resource platform, where the video content obtaining request is an Invite packet, and the video content obtaining request includes a URL.

502: After receiving the video content obtaining request, the video conversion server returns a 100 Trying message to the telecommunication video resource platform.

503: The video conversion server sends a 180 Alerting packet to the telecommunication video resource platform.

504: The video conversion server parses the video content obtaining request, and obtains web server address information corresponding to the URL.

505: The video conversion server uses the HTTP protocol to request web page content of a web server, according to the web server address information.

506: The video conversion server receives the web page content sent by the web server.

507: The video conversion server converts the web page content into a video stream, determines a video encoding and decoding format, and determines IP address information for sending a video stream over a network transmission protocol such as RTP or RCTP, where the IP address information is address information of the telecommunication video resource platform.

Here, the video conversion server may implement this function through a computer, and reference may be made to the foregoing text for specific implementation.

508: The video conversion server feeds back an SIP standard protocol 200 OK packet to the telecommunication video resource platform.

509: The video conversion server sends the converted video stream to the telecommunication video resource platform according to the determined IP address information, and finally sends the converted video stream to the telecommunication network through the telecommunication video resource platform.

The foregoing application instance of the present invention is applied to a scenario where dynamic information has a lot of changes, and a reason why the video stream needs to be sent to the telecommunication video resource platform is that, the telecommunication video resource platform needs to process the video stream. For example, when a device in the telecommunication network supports a video stream that is in an H.324 multiplexed stream manner and no independent VIG device exists in the telecommunication network, the telecommunication video resource platform is required to perform packaging of the video stream that is in the H.324 multiplexed stream manner. In addition, when the device in the telecommunication network and the video conversion server have no encoding and decoding intersection, the telecommunication video resource platform is required to perform conversion of an encoding and decoding format of the video stream into an encoding and decoding format acceptable for the device in the telecommunication network.

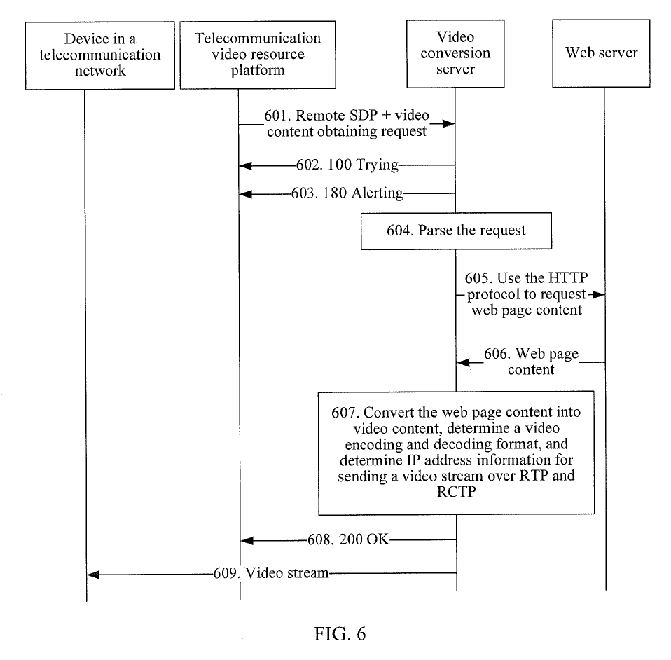

(3) As shown in FIG. 6, it is a schematic flow chart of providing a real-time video service in a telecommunication network according to a third instance of the present invention, which specifically includes:

601: A video conversion server receives a video content obtaining request and a remote Session Description Protocol (Session Description Protocol, SDP) packet that are sent from a telecommunication video resource platform, where the video content obtaining request and the SDP packet are Invite packets, the video content obtaining request includes a URL, and the SDP packet includes address information of a device in the telecommunication network.

602: After receiving the video content obtaining request and the remote SDP packet, the video conversion server returns a 100 Trying message to the telecommunication video resource platform.

603: The video conversion server sends a 180 Alerting packet to the telecommunication video resource platform.

604. The video conversion server parses the video content obtaining request, obtains web server address information corresponding to the URL, and obtains, through the remote SDP packet, the address information of the device in the telecommunication network.

605: The video conversion server uses the HTTP protocol to request web page content of a web server, according to the web server address information.

606: The video conversion server receives the web page content sent by the web server.

607: The video conversion server converts the web page content into a video stream, determines a video encoding and decoding format, and determines IP address information for sending a video stream over a network transmission protocol such as RTP or RCTP, where the IP address information is address information of the device in the telecommunication network.

608: The video conversion server feeds back an SIP standard protocol 200 OK packet to the telecommunication video resource platform.

609: The video conversion server sends the converted video stream to the device in the telecommunication network, according to the determined address information of the device in the telecommunication network.

The device in the telecommunication network may be a terminal in an IMS, or a terminal in a NGN network, or may be a VIG gateway in the telecommunication network.

The foregoing application instance of the present invention is applied to a scenario where dynamic information has a lot of changes. Here, if it is determined that the converted video stream is acceptable for the device in the telecommunication network, the video stream may be directly sent to the device in the telecommunication network, and it is unnecessary for the telecommunication video resource platform to perform conversion of an encoding and decoding format of the video stream into an encoding and decoding format acceptable for the device in the telecommunication network.

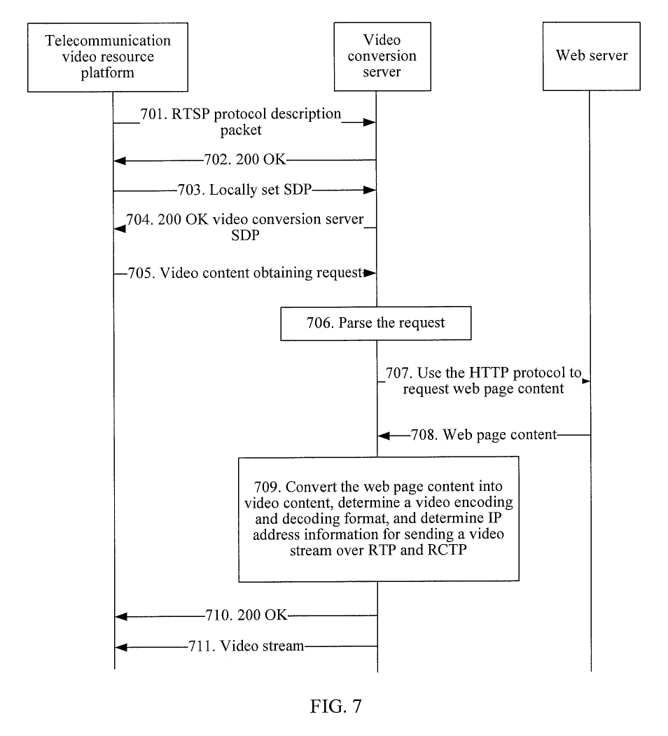

(4) As shown in FIG. 7, it is a schematic flow chart of providing a real-time video service in a telecommunication network according to a fourth instance of the present invention, which specifically includes:

701: A video conversion server receives an RTSP protocol description packet sent from a telecommunication video resource platform.

702: The video conversion server sends a 200 OK packet to the telecommunication video resource platform.

703: The video conversion server receives a locally set SDP packet sent by the telecommunication video resource platform, where the packet includes IP address information of the telecommunication video resource platform.

704: The video conversion server sends a 200 OK video conversion server SDP acknowledgment packet to the telecommunication video resource platform.

705: The video conversion server receives a video content obtaining request sent from the telecommunication video resource platform, where the video content obtaining request includes a URL.

706: The video conversion server parses the video content obtaining request, and obtains web server address information corresponding to the URL.

707: The video conversion server uses the HTTP protocol to request web page content, according to the web server address information.

708: The video conversion server receives the web page content sent by a web server.

709: The video conversion server converts the web page content into a video stream, determines a video encoding and decoding format, and determines IP address information for sending a video stream over a network transmission protocol such as RTP or RCTP, where the IP address information is the address information of the telecommunication video resource platform.

710: The video conversion server feeds back an RTSP standard protocol 200 OK packet to the telecommunication video resource platform.

711: The video conversion server sends the converted video stream to the telecommunication video resource platform according to the determined IP address information, and finally sends the converted video stream to the telecommunication network through the telecommunication video resource platform.

The foregoing application instance of the present invention is applied to a scenario where dynamic information has a lot of changes, and a reason why the video stream is sent to the telecommunication video resource platform is that, the telecommunication video resource platform needs to process the video stream. For example, when a device in the telecommunication network supports a video stream that is in an H.324 multiplexed stream manner and no independent VIG device exists in the telecommunication network, the telecommunication video resource platform is required to perform packaging of the video stream in the H.324 multiplexed stream manner. In addition, when the device in the telecommunication network and the video conversion server have no encoding and decoding intersection, the telecommunication video resource platform is required to perform conversion of an encoding and decoding format of the video stream into an encoding and decoding format acceptable for the device in the telecommunication network.

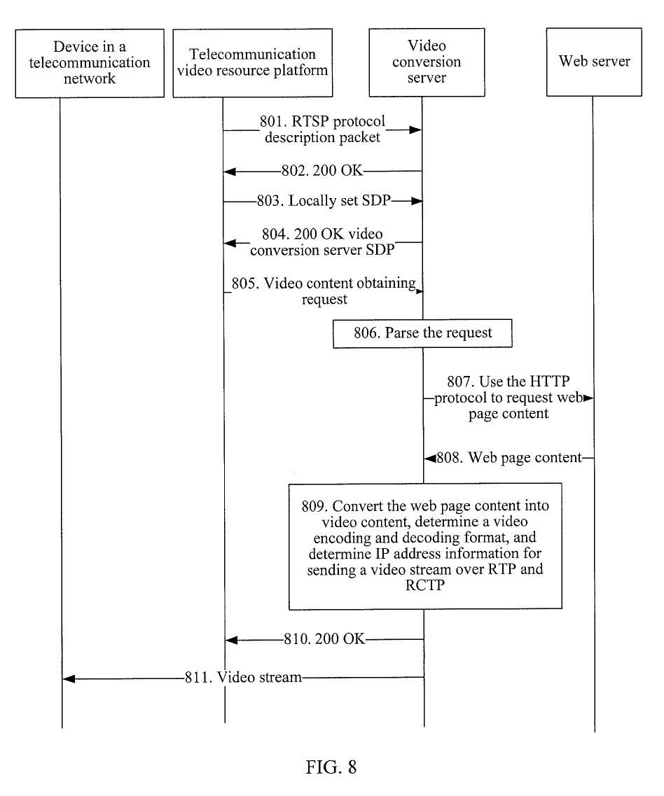

(5) As shown in FIG. 8, it is a schematic flow chart of providing a real-time video service in a telecommunication network according to a fifth instance of the present invention, which specifically includes:

801: A video conversion server receives an RTSP protocol description packet sent from a telecommunication video resource platform.

802: The video conversion server sends a 200 OK packet to the telecommunication video resource platform.

803: The video conversion server receives a locally set SDP packet sent from the telecommunication video resource platform, where the packet includes address information of a device in the telecommunication network.

It should be noted that, in comparison with the corresponding step 703 in FIG. 7, in this step, the address information included in the SDP packet is different. In step 703, if the telecommunication video resource platform determines that the device in the telecommunication network may accept the converted video stream, the telecommunication video resource platform may directly include, in the SDP packet, the address information of the device in the telecommunication network, and send the video conversion server the SDP packet including the address information. Subsequently, the video conversion server directly sends a successfully converted video stream to the device in the telecommunication network, and it is unnecessary for the telecommunication video resource platform to perform conversion of an encoding and decoding format of the video stream into an encoding and decoding format acceptable for the device in the telecommunication network. In this embodiment as well as the embodiment in FIG. 7, the telecommunication video resource platform sends a video content obtaining request to the video conversion server in response to a request (the request includes the address information of the device in the telecommunication network) of the device in the telecommunication network, the telecommunication video resource platform may obtain, through the request of the device in the telecommunication network, the address information of the device in the telecommunication network.

804: The video conversion server sends a 200 OK video conversion server SDP acknowledgment packet to the telecommunication video resource platform.

805: The video conversion server receives the video content obtaining request from the telecommunication video resource platform, where the video content obtaining request includes a URL.

806. The video conversion server parses the URL in the video content obtaining request, obtains web server address information corresponding to the URL, and obtains, through the locally set SDP packet, the address information of the device in the telecommunication network.

807: The video conversion server uses the HTTP protocol to request web page content of a web server, according to the web server address information.

808: The video conversion server receives the web page content sent by the web server.

809: The video conversion server converts the web page content into a video stream, determines a video encoding and decoding format, and determines IP address information for sending a video stream over a network transmission protocol such as RTP or RCTP, where the IP address information is the address information of the device in the telecommunication network.

810: The video conversion server feeds back an RTSP standard protocol 200 OK packet to the telecommunication video resource platform.

811: The video conversion server sends the converted video stream to the device in the telecommunication network, according to the determined address information of the device in the telecommunication network.

The device in the telecommunication network may be a terminal in the IMS, or a terminal in the NGN network, or may be a VIG gateway in the telecommunication network.

The foregoing application instance of the present invention is applied to a scenario where dynamic information has a lot of changes. Here, if it is determined that the converted video stream is acceptable for the device in the telecommunication network, the converted video stream may be directly sent to the device in the telecommunication network, and it is unnecessary for the telecommunication video resource platform to perform conversion of an encoding and decoding format of the video stream into an encoding and decoding format acceptable for the device in the telecommunication network.

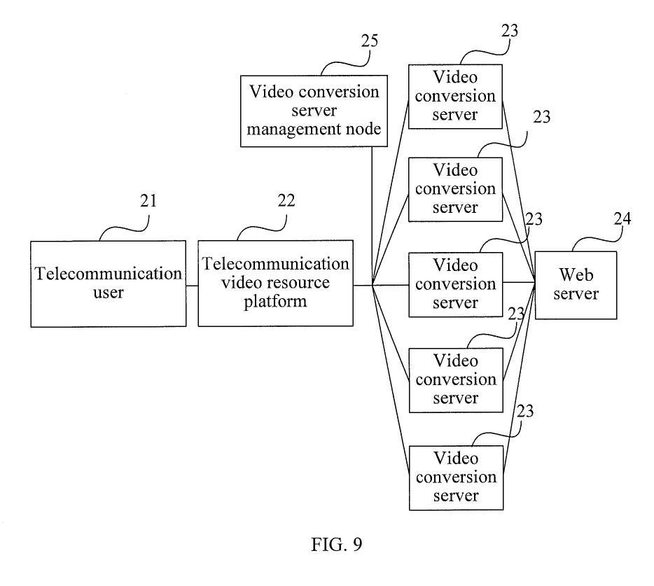

Optionally, the receiving unit 301 in FIG. 3 above may further be configured to, after video content obtaining requests are distributed by a video conversion server management node, receive a video content obtaining request sent by the telecommunication video resource platform. As shown in FIG. 9, it is an improved schematic structural diagram in which a video conversion server management node has been added on basis of FIG. 2 according to an embodiment of the present invention, where the video conversion server management node 25 is responsible for managing and allocating multiple video conversion servers 23.

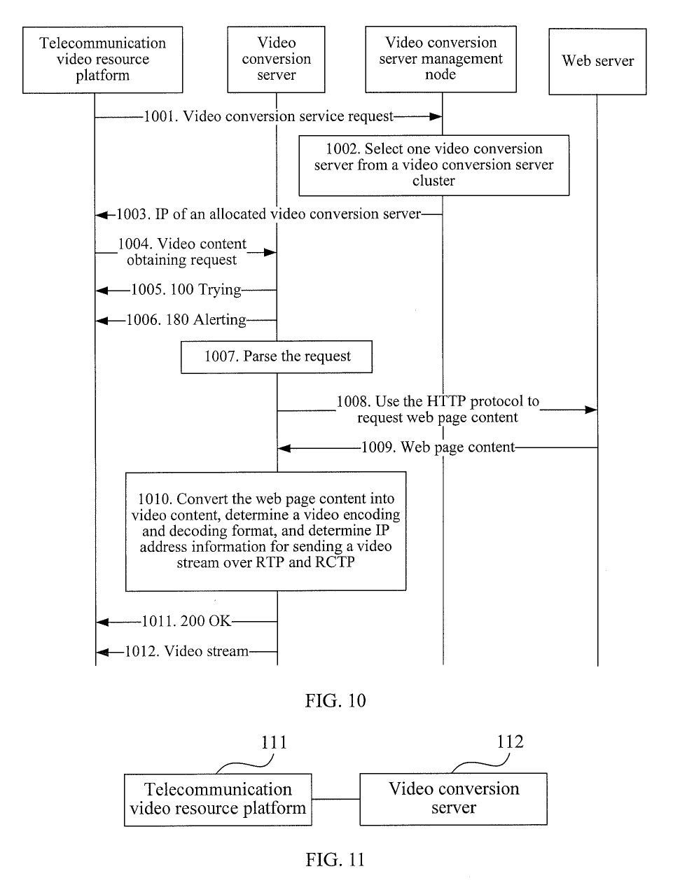

As shown in FIG. 10, it is a schematic flow chart of providing a real-time video service in a telecommunication network according to a sixth instance of the present invention, which specifically includes:

1001: A video conversion server management node receives a video conversion service request sent by a telecommunication video resource platform, where the video conversion service request is an Invite packet and is used for requesting a video conversion service.

1002: The video conversion server management node selects one video conversion server from a video conversion server cluster.

It should be noted that, in the embodiment of the present invention, one video conversion server may be selected from the video conversion server cluster according to a load sharing principle (for example, factors such as a busy state and load state of a video conversion server may be considered). This is only an instance, and other allocation manners may also be adopted, which does not serve as a limitation on the embodiment of the present invention.

1003: The video conversion server management node sends an SIP message to the telecommunication video resource platform, where the SIP message includes IP address information of an allocated video conversion server, and the allocated video conversion server provides the video conversion service for the telecommunication video resource platform.

1004: The video conversion server receives a video content obtaining request sent by the telecommunication video resource platform, where the video content obtaining request includes a URL.

1005: The video conversion server sends a 100 Trying message to the telecommunication video resource platform.

1006: The video conversion server sends a 180 Alerting packet to the telecommunication video resource platform.

1007: The video conversion server parses the URL in the video content obtaining request, and obtains web server address information corresponding to the URL.

1008: The video conversion server uses the HTTP protocol to request web page content, according to the web server address information.

1009: The video conversion server receives the web page content sent by a web server.

1010: The video conversion server converts the web page content into a video stream, determines a video encoding and decoding format, and determines IP address information for sending a video stream over a network transmission protocol such as RTP or RCTP, where the IP address information is address information of the telecommunication video resource platform.

1011: The video conversion server feeds back an SIP standard protocol 200 OK packet to the telecommunication video resource platform.

1012: The video conversion server sends the converted video stream to the telecommunication video resource platform according to the determined IP address information, and finally sends the converted video stream to the telecommunication network through the telecommunication video resource platform.

The foregoing application instance of the present invention is applied to a scenario with large volume of video content obtaining requests. With the increase of the service volume, multiple video conversion servers may exist in a system, and in this case, may be managed by the telecommunication video resource platform in a unified manner, and may interact with one added video conversion server management node component in the manner in the foregoing application instance. The video conversion server management node manages and allocates the video conversion servers. When requiring the video conversion service, the telecommunication video resource platform just needs to first interact with the video conversion server management node to obtain an allocated video conversion server resource.

In the foregoing device technical solution in the embodiment of the present invention, technical measures that the receiving unit receives the video content obtaining request from the telecommunication video resource platform, the obtaining unit obtains, according to the video content obtaining request, the data content that is of a web server and corresponds to the video content obtaining request, the converting unit converts the data content into the display content in the video form, and the sending unit sends the display content in the video form are adopted, so a capability of generating video content dynamically in real time according to dynamic information is got, and the open efficiency is high. Several implementation manners are suitable for different scenarios, so a development capacity of a telecommunication video service is increased greatly. For example, a file manner is suitable for content of which display content does not change often, for example, querying a telephone bill of the user. An SIP manner and RTSP manner are suitable for content changing greatly or content with a high periodic changing frequency, such as checking stock quotes. This solution and architecture are not only used for displaying a web page, and all display effects that can be made by an IT technology can be easily converted into video streams in the telecommunication network with this architecture.

An embodiment of the present invention further provides a system for providing a real-time video service in a telecommunication network, as shown in FIG. 11, which includes:

a video conversion server 111, configured to receive a video content obtaining request from a telecommunication video resource platform 112, obtain, according to the video content obtaining request, data content that is of a web server and corresponds to the video content obtaining request, convert the data content into display content in a video form, and send the display content in the video form; and

the telecommunication video resource platform 112, configured to send the video content obtaining request to the video conversion server 111.

Persons of ordinary skill in the art can understand that all or part of the steps in the method according to the embodiments of the present invention may be completed by a program instructing relevant hardware, and the program may be stored in a computer readable storage medium. When the program is run, all or part of the foregoing steps are included. The storage medium includes a ROM/RAM, a magnetic disk, or an optical disk, and so on.

The objectives, technical solutions, and beneficial effects of the present invention are illustrated in further detail through the foregoing specific embodiment manners. It should be understood that the foregoing descriptions are merely specific embodiment manners of the present invention, but not intended to limit the protection scope of the present invention. Any modification, equivalent replacement, or improvement made without departing from the spirit and principle of the present invention shall fall within the protection scope of the present invention.

What is claimed is:

1. A method for providing a real-time video service in a telecommunication network, wherein the method comprises:
receiving a video content obtaining request from a telecommunication video resource platform;
obtaining, according to the video content obtaining request, data content that is of a web server and corresponds to the video content obtaining request;
converting the data content into display content in a video form; and
sending the display content in the video form.

2. The method according to claim 1, wherein the obtaining, according to the video content obtaining request, the data content that is of a web server and corresponds to the video content obtaining request comprises:
according to a uniform resource locator URL in the video content obtaining request, obtaining data content that is in a web page form, is of the web server and corresponds to the URL.

3. The method according to claim 1, wherein the sending the display content in the video form comprises:
sending the display content in the video form to the telecommunication video resource platform, wherein the video form is an image or a media stream, or
according to address information in a Session Description Protocol SDP packet, sending the display content in the video form to a device that corresponds to the address information and is in the telecommunication network, wherein the device that corresponds to the address information and is in the telecommunication network comprises one of the following: a terminal of an IP multimedia subsystem IMS network, or a terminal of a next generation network NGN, or a third generation mobile communication technology 3G video gateway VIG in the telecommunication network.

4. The method according to claim 1, wherein a network transmission protocol of the display content in the video form is a Real-time Transport Protocol RTP and an RTP Control Protocol RTCP.

5. The method according to claim 3, wherein after a session is established with the telecommunication video resource platform in one of the following session establishing manners: a File Transfer Protocol FTP, a Hypertext Transfer Protocol HTTP, a Session Initiation Protocol SIP, and a Real-time Streaming Protocol RTSP, and the display content in the video form is sent to the telecommunication video resource platform.

6. The method according to claim 1, wherein the receiving the video content obtaining request from the telecommunication video resource platform comprises:
receiving the video content obtaining request sent by the telecommunication video resource platform.

7. The method according to claim 1, wherein the receiving the video content obtaining request from the telecommunication video resource platform comprises:
after video content obtaining requests are distributed by a video conversion server management node, receiving the video content obtaining request sent by the telecommunication video resource platform.

8. A video conversion server for providing a real-time video service in a telecommunication network, wherein the video conversion server comprises:
a receiving unit, configured to receive a video content obtaining request from a telecommunication video resource platform;
an obtaining unit, configured to obtain, according to the video content obtaining request, data content that is of a web server and corresponds to the video content obtaining request;
a converting unit, configured to convert the data content into display content in a video form; and
a sending unit, configured to send the display content in the video form.

9. The video conversion server according to claim 8, wherein the obtaining unit is further configured to obtain, according to a uniform resource locator URL in the video content obtaining request, data content that is in a web page form, is of the web server and corresponds to the URL.

10. The video conversion server according to claim 8, wherein the sending unit is further configured to send the display content in the video form to the telecommunication video resource platform, wherein the video form is an image or a media stream, or configured to send, according to address information in a Session Description Protocol SDP packet, the display content in the video form to a device that corresponds to the address information and is in the telecommunication network, wherein the device that corresponds to the address information and is in the telecommunication network comprises one of the following: a terminal of an IP multimedia subsystem IMS network, or a terminal of a next generation network NGN network, or a third generation mobile communication technology 3G video gateway VIG in the telecommunication network.

11. The video conversion server according to claim 8, wherein for the sending unit, a network transmission protocol used for sending the display content in the video form is a Real-time Transport Protocol RTP and an RTP Control Protocol RTCP.

12. The video conversion server according to claim 10, wherein the video conversion server further comprises:
a session establishing unit, configured to establish a session with the telecommunication video resource platform in one of the following session establishing manners: a File Transfer Protocol FTP, a Hypertext Transfer Protocol HTTP, a Session Initiation Protocol SIP, and a Real-time Streaming Protocol RTSP, wherein afterwards, the sending unit sends the display content in the video form to the telecommunication video resource platform.

13. The video conversion server according to claim 8, wherein the receiving unit is further configured to receive the video content obtaining request sent by the telecommunication video resource platform.

14. The video conversion server according to claim 8, wherein the receiving unit is further configured to, after video content obtaining requests are distributed by a video conversion server management node, receive the video content obtaining request sent by the telecommunication video resource platform.

15. A system for providing a real-time video service in a telecommunication network, wherein the system comprises:
a video conversion server, configured to receive a video content obtaining request from a telecommunication video resource platform, obtain, according to the video content obtaining request, data content that is of a web server and corresponds to the video content obtaining request, convert the data content into display content in a video form, and send the display content in the video form; and
the telecommunication video resource platform, configured to send the video content obtaining request to the video conversion server.
